(19) United States
(12) Patent Application Publication
(10) Pub. No.: US 2006/0010733 A1
(43) Pub. Date: Jan. 19, 2006

(54) Innovative mindsets printed on contrasting background of flat material that adhere to base material for application to desired locations

(76) Inventors: Floris Pittler, Mission Viejo, CA (US); Carl Pittler, Mission Viejo, CA (US)

Correspondence Address: Floris Pittler and Carl Pittler, 21911 Tobarra, Mission Viejo, CA, 92692-4210, US

(21) Appl. No.: 10/893,672

(22) Filed: Jul. 15, 2004

(51) Int. Cl. G09F 1/00

(52) U.S. Cl. 40/124.06

(57) ABSTRACT

An innovative mindset group is a useful and safe invention consisting of top portions of flat material that have printing which is contrasting with the background to provide a clear innovative mindset to assist on a short term or continual basis with remembering tasks to be completed or occurrences to observe and a smaller bottom portion of strong material that allows for the top portion's adherence and for the said bottom portion's underneath to adhere to a chosen location.

### FEDERALLY SPONSORED RESEARCH

Not Applicable

### SEQUENCE LISTING OR PROGRAM

Not Applicable

### BACKGROUND OF THE INVENTION

This invention relates to material “Innovative Mindsets” for everyday use in various formats and at various locations.

### BACKGROUND—DESCRIPTION OF PRIOR ART

Prior to our invention, these types of signs and objects were generally produced for use for specific work or occasion types, i.e. “Wet Paint”, “Do Not Enter”, “Happy Birthday”, “Congratulations”, “a picture of a flag for a specific country's celebration”, etc. It is important for us to clarify Mindset. It explains a thought process that will aid an individual to complete a necessary task or be aware of a specific occurrence. The repeated observance of a Mindset placed at strategic locations, during each day, will assist the individual(s) to accomplish tasks or be aware of a happening on a timely basis. These specific Mindsets are not currently in use. During our research, we visited and observed various retail and discount store products for likenesses to our “Mindsets” titled above. Also, we accessed various internet web-sites for similar products. Some examples of the types of businesses and products are:

(1) Office supply, hobby supply, linen and kitchen stores, department stores. They sell (a) Named forms that will attach to a surface that holds a magnetic strip; (b) blank paper adhesive sheets for writing reminders and (c) other various signs and object forms and text that could be permanently or semi-permanently attached to various surfaces or “a picture of a flag for a specific country, etc.

(2) Car Washes that carry a variety of (a) reminder tablets that adhere to the window and above the radio area. These tablets are blank and are generally used to write notes on. Also, (b) Sun visor holders for writing tablets and calendars, etc. are shown also. The writing tablets are generally located in an area of a larger pocket type holder that is attached to the sun visor with elastic straps. These holders are generally used for various items.

(3) Internet web-sites accessed were searched using words such as reminders, tablets, signs, banners, etc. Generally, all of the sites we researched showed the same or similar items such as stated in (1) and (2) above.

The products we researched were primarily lacking in (i) safety as a major factor (ii) ease of continued use on all surfaces and (iii) ease of intended use by individuals in their everyday lives.

Our comments relating to the products mentioned in (1) above are: (a) all surfaces will not hold magnets. (b) Blank paper adhesive sheets must be written on. Many locations are not safe for writing-specifically automobiles or other driving equipment when in operation. In addition, blank paper adhesive sheets are generally written on once and thrown away. This causes a waste of paper and trees. It hastens destruction of our environment. (c) No product was based specifically on an individual's everyday needs.

In regard to the car wash products mentioned in (2) above, our comments are: (a) and (b) The availability of writing paper in such locations that are readily available to the driver is a major impediment to safety. It is impossible to stop individuals from doing something like writing while driving. This is true even when they are reminded of the danger to themselves and others.

### OBJECTS AND ADVANTAGES

Although we have noted many disadvantages to similar type products above, several objects and advantages of our current invention are:
(a) to provide an “Innovative Mindset” process for use that will allow every individual the opportunity to feel safe with the use of our product.
(b) to provide an “Innovative Mindset” that is appropriate for an individual's single or multiple use everyday;
(c) to provide usage on various kinds of surfaces appropriate to each individual's need on a daily basis.
(d) to provide a durable and easy to maintain product that will be used everyday.
(e) to provide an easy to read and user friendly product that will help individuals accomplish priorities for each day.
(f) to provide personalized “Innovative Mindset(s)”, if required, for individuals with special needs.
(g) to provide basic colors and individualized colors to match personal preferences.
(h) to provide a clear divided holder for “Innovative Mindset(s)” ease of use and storage.

Further objects and advantages are to provide a product that not only adheres to the qualities above, but is also affordable for working and retired individuals by using innovative methods of manufacturing our product that insures quality at a low cost Still further objects and advantages will become apparent from a consideration of the ensuing drawings and descriptions.

### SUMMARY OF THE INVENTION

In accordance with our present invention, innovative mindsets' consist of multiple pieces of flat material with various words or symbols that allows a person to be aware that a task needs to be accomplished or that an occurrence is scheduled.

### BRIEF DESCRIPTION OF THE VIEWS OF THE DRAWINGS

FIG. 1 shows the top specific format of the mindset.

References for FIG. 1:

A1—oval mindset with contrasting background color.

A2—printed name of specific mindset.

A3—printed product name.

A4—printed sponsor name.

References for FIG. 2:

FIG. 2 shows the smaller base format for each of the various top mindsets used.

B1—oval base with contrasting background to which any of the mindsets may attach.

B2—printed statement PLACE MINDSET HERE.

B3—printed product name.

B4—printed sponsor name.

Note: The Mindset top section (FIG. 1) is slightly larger than the base for easy removal. (See drawing sheet 1/2.)

FIG. 3 shows the holder for the mindsets.

C1—clear type holder.

C2—dividers within holder for each specific mindset group.

C3—button with string on outside of holder cover portion.

C4—button at front of holder to attach said string of C3.

Note: See drawing sheet 2/2 for the holder drawing.

### DETAILED DESCRIPTION OF THE PREFERRED EMBODIMENT

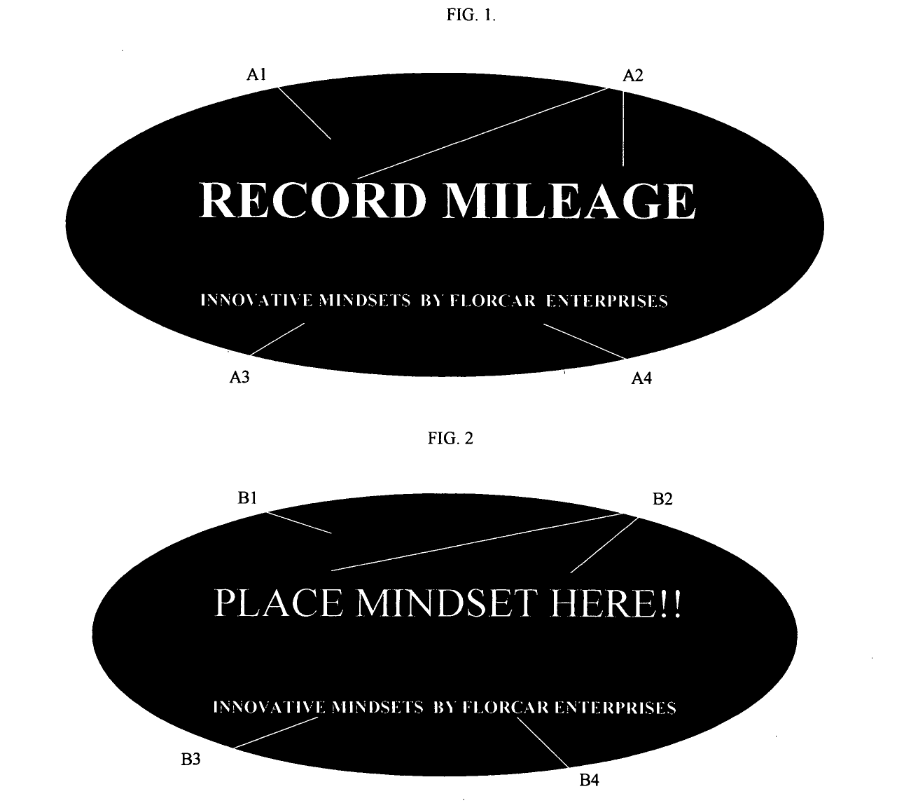

### Description—FIGS. 1, 2 and 3—Preferred Embodiment

In order that the invention may be more readily understood, a preferred embodiment will now be described with reference to the accompanying drawings in which:

A preferred embodiment of the top format example of the present invention is illustrated in FIG. 1 (top view). Areas of FIG. 1 are as follows: A1 shows the plain background. A2 of the innovative mindset contains words to set into ones memory for use in the short term. The repeated viewing of the mindset will enable a person to perform necessary tasks easily. A3 contains the title of the present invention. A4 contains the sponsor's name. The general idea is that the innovative mindset will be used multiple times. Different words will be on separate mindsets. Therefore each individual mindset will allow for the needs of the individual. This top format could be constructed of various materials with some duration and strength for repeated use. It would be possible to use strong woven fabric, plastic, etc. The shape could be as shown in oval example or square, round, oblong, rectangle or shapes according to specific requests. Using a specific request shape would require both the top and base portions to be manufactured in the same shape. Although not shown, the bottom of the FIG. 1 mindset will adhere to the FIG. 2 base. This bottom will allow for multiple adherence and removal from the base.

FIG. 2 is the preferred embodiment of the base. B1 is the background of the base. B2 shows the words permanently stated on the base as “PLACE MINDSET HERE”. This comment reinforces the process of using each mindset. B3 contains the title of the present invention. B4 contains the sponsor's name. This FIG. 2 base will contain a covering substance that FIG. 1 will adhere to. This substance will allow for repeated attaching and removing of FIG. 1's mindset The bottom of FIG. 2 will contain a strong attachment material that could be permanently attached to a desired surface.

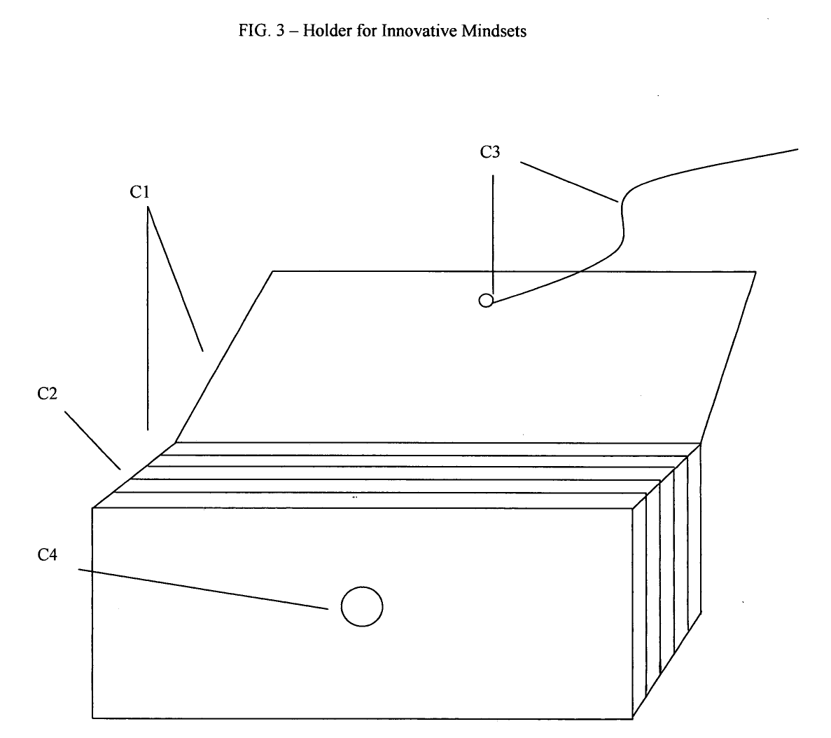

FIG. 3 is the preferred embodiment of the holder. C1 is a clear type holder that will show the groups of mindsets inside. C2 shows the view of the dividers for separating the mindset groups within the holder. C2 is not accordion in nature. C2 is a four-sided box type that allows sufficient room in separate sections to hold mindsets. C3 shows the button and tie on the outside of holder. C4 shows the front of the holder button to tie said C3 string to for keeping the holder closed to protect the mindsets inside.

### CONCLUSION, RAMIFICATIONS, AND SCOPE

As described and shown above, much exactness is contained, but this should not be understood as a limit on the scope of the invention but to simply describe the preferred embodiment of the invention. Our intention is for the reader to understand our dedication to providing an invention that considers the need, ease of use and safety of the user.

We claim:

1. A first innovative mindset group consisting of a top portion of flat material that allows a person to be aware of such areas as a task that is to be accomplished or that an occurrence is scheduled;
and wherein the underside of the top portion has a finish that allows for adherence/removal to/from a base portion:
and wherein the base portion is composed of material with a top finish that allows adherence of the top portion and the base portion is also composed of material with an underneath finish that allows adherence to a chosen location where viewing may be done safely and with ease;
and wherein a multiplicity of top portions of the innovative mindset consists of a variety of printed words in the center that contrast with the background thereby allowing the printed area to stand out;
and wherein the size of the said top portion will be slightly larger than the base portions for ease in removal to allow for changing the top portion of the innovative mindset desired and/or applying said top portion to a different chosen base portion location;

2. A second innovative mindset group containing the said first innovative mindset group and a holder;
and wherein the holder consisting of a clear type container with dividers that will hold various first innovative mindset groups;
and wherein the holder is composed of a material that allows for viewing the holder's general contents;
and wherein the holder will include a closure thereby allowing the innovative mindset groups to remain inside the holder and be protected for future use;
and wherein the enclosure is a button and a tie.
